(19) United States
(12) Patent Application Publication
(10) Pub. No.: US 2025/0029601 A1
(43) Pub. Date: Jan. 23, 2025

(54) DETECTING SYNTHETIC SPEECH

(71) Applicant: SRI International, Menlo Park, CA (US)

(72) Inventors: MD Hafizur Rahman, Santa Clara, CA (US); Mitchell Leigh McLaren, Everton Park (AU); Aaron Dennis Lawson, Sutter Creek, CA (US)

(21) Appl. No.: 18/769,197

(22) Filed: Jul. 10, 2024

Related U.S. Application Data
(60) Provisional application No. 63/528,143, filed on Jul. 21, 2023.

(51) Int. Cl. G10L 15/16; G10L 15/32

(52) U.S. Cl. CPC G10L 15/16; G10L 15/32

(57) ABSTRACT

In general, the disclosure describes techniques for detecting synthetic speech of a speaker. In an example, a machine learning system may be configured to generate, using a deep learning model trained to distinguish between synthetic speech and authentic speech, reference embeddings for the speaker that characterize a first set of acoustic features and a first set of phonetic features associated with the speaker. The machine learning system may further be configured to generate, using the deep learning model, a test embedding for an audio clip that characterizes a second set of acoustic features and a second set of phonetic features associated with the audio clip. The machine learning system may further be configured to compute a score based on the test embedding and the reference embeddings. The machine learning system may further be configured to output, based on the score, an indication of whether the audio clip includes synthetic speech.

### RELATED APPLICATIONS

This application claims the benefit of U.S. Patent Application No. 63/528,143, filed Jul. 21, 2023, which is incorporated by reference herein in its entirety.

### GOVERNMENT RIGHTS

This invention was made with government support under contract number DENA0003525 awarded by National Technology and Engineering Solutions of Sandia, LLC under contract by Department of Energy. The Government has certain rights in the invention.

### TECHNICAL FIELD

This disclosure relates to machine learning systems and, more specifically, to machine learning systems to detect synthetic speech.

### BACKGROUND

Deep fakes are increasingly becoming a concern of national interest that has fueled the rapid spread of false information to the public through manipulated media. Deep fakes often include audio of synthetic speech generated by emulating or cloning a speaker. Synthetic speech may be generated by many different techniques for speech generation, such as applying various text to speech models.

### SUMMARY

In general, the disclosure describes techniques for detecting synthetic speech in audio clips based on phonetic characteristics and speaker specific characteristics. A machine learning system may be trained to extract acoustic features and phonetic features from sample speech clips of a speaker to be registered. Acoustic features may include characteristics of audio signals associated with different frequency components associated with the audio signals. Phonetic features may include characteristics of various aspects of speech sounds (e.g., pronunciations of phones or phonemes). The machine learning system may generate enrollment feature vectors that characterize, represent, capture, or otherwise reflect acoustic features and phonetic features of the speech included in the sample speech clips of the speaker to be registered. The machine learning system may generate reference embeddings for the speaker to be registered based on the enrollment feature vectors. The machine learning system may generate the reference embeddings using a deep learning model trained to distinguish between synthetic speech purporting to be spoken by a speaker and authentic speech spoken by the speaker. In this way, the machine learning system may generate reference embeddings that are more speaker aware based on speaker specific information. The machine learning system may store the reference embeddings to register the speaker.

The machine learning system may apply the reference embeddings to determine whether a test audio clip includes synthetic speech purporting to be spoken by the registered speaker. The machine learning system may extract acoustic features and phonetic features from speech included in the test audio clip. The machine learning system may generate test feature vectors that characterize, capture, represent, or otherwise reflect the acoustic features and phonetic features of speech included in the test audio clip. The machine learning system may generate test embeddings for the test audio based on the test feature vectors. The machine learning system may generate test embeddings using a deep learning model trained to distinguish between synthetic speech and authentic speech. In this way, the machine learning system may generate test embeddings based on learning how to identify distinctions between synthetic speech and authentic speech (e.g., identify synthetic speech acoustic artifacts, synthetic speech phonetic artifacts, etc.). The machine learning system may determine, based on the test embeddings and the reference embeddings, whether the test audio includes synthetic speech purporting to be spoken by the registered speaker. For example, the machine learning system may apply Probabilistic Linear Discriminate Analysis (PLDA) techniques to discriminate, based on the test embeddings and the reference embeddings, authentic speech of the registered speaker and synthetic speech purporting to be spoken by the registered speaker. The machine learning system may apply the PLDA techniques to compute a score for the test audio clip that indicates a probability or likelihood that the test audio includes synthetic speech. The machine learning system may output an indication of whether the test audio includes synthetic speech based on the score.

The techniques may provide one or more technical advantages that realize at least one practical application. For example, the machine learning system, in accordance with the techniques described herein, may learn to distinguish between phonetic artifacts of authentic speech from phonetic artifacts left in synthetic speech generated using a synthetic speech generator. Conventionally, systems may be limited to information associated with acoustic features without analyzing higher-level information such as pronunciation of phones (sub-units of words) included in phonetic features. By analyzing phonetic features of audio clips in synthetic speech detection, the machine learning system, in accordance with the techniques described herein, may detect synthetic speech based on modelling characteristics associated with general pronunciation by a population, allowing the machine learning system to detect when such characteristics are not met by synthetic speech generated by various synthetic speech generators. In this way, the machine learning system may detect synthetic speech generated from synthetic speech generators with high accuracy based on the analysis of phonetic features included in audio clips.

The machine learning system, in accordance with the techniques described herein, may determine whether audio clips include synthetic speech based on acoustic features and phonetic features associated with speech from registered speakers. The machine learning system may apply reference embeddings that represent speaker specific characteristics of registered speakers to improve synthetic speech detection in real-world conditions. For example, by capturing phonetic features in reference embeddings (e.g., via the machine learning system learning differences in speaker specific production of phones), the machine learning system may improve detection of synthetic speech purporting to be spoken by individuals (including, e.g., political figures, celebrities, etc.) that may be susceptible to fraudulent impersonation attempts because of the abundance of publicly available speech data for the individuals.

In one example, a method includes generating, using a deep learning model trained to distinguish between synthetic speech and authentic speech, one or more reference embeddings for the speaker, wherein the one or more reference embeddings characterize a first set of acoustic features and a first set of phonetic features associated with the speaker. The method may further include generating, using the deep learning model trained to distinguish between synthetic speech and authentic speech, a test embedding for an audio clip that characterizes a second set of acoustic features and a second set of phonetic features associated with the audio clip. The method may further include computing a score based on the test embedding and the one or more reference embeddings. The method may further include outputting, based on the score, an indication of whether the audio clip includes synthetic speech.

In another example, a computing system may include processing circuitry and memory for executing a machine learning system. The machine learning system may be configured to generate, using a deep learning model trained to distinguish between synthetic speech and authentic speech, one or more reference embeddings for the speaker, wherein the one or more reference embeddings characterize a first set of acoustic features and a first set of phonetic features associated with the speaker. The machine learning system may further be configured to generate, using the deep learning model trained to distinguish between synthetic speech and authentic speech, a test embedding for an audio clip that characterizes a second set of acoustic features and a second set of phonetic features associated with the audio clip. The machine learning system may further be configured to compute a score based on the test embedding and the one or more reference embeddings. The machine learning system may further be configured to output, based on the score, an indication of whether the audio clip includes synthetic speech.

In another example, computer-readable storage media may include machine readable instructions for configuring processing circuitry to generate, using a deep learning model trained to distinguish between synthetic speech and authentic speech, one or more reference embeddings for the speaker, wherein the one or more reference embeddings characterize a first set of acoustic features and a first set of phonetic features associated with the speaker. The processing circuitry may further be configured to generate, using the deep learning model trained to distinguish between synthetic speech and authentic speech, a test embedding for an audio clip that characterizes a second set of acoustic features and a second set of phonetic features associated with the audio clip. The processing circuitry may further be configured to compute a score based on the test embedding and the one or more reference embeddings. The processing circuitry may further be configured to output, based on the score, an indication of whether the audio clip includes synthetic speech.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example computing environment in which a computing system detects whether audio includes synthetic speech, in accordance with techniques of this disclosure.

FIG. 2 is a block diagram illustrating an example computing system with an example machine learning system trained to detect synthetic speech purporting to be spoken by a registered speaker, in accordance with techniques of this disclosure.

FIG. 3 is a conceptual diagram illustrating an example machine learning system of a computing system for registering a speaker and detecting synthetic speech in an example test audio clip, in accordance with techniques of this disclosure.

FIG. 4 is a flowchart illustrating an example mode of operation for determining synthetic speech in an audio clip, in accordance with techniques of this disclosure.

Like reference characters refer to like elements throughout the figures and description.

### DETAILED DESCRIPTION

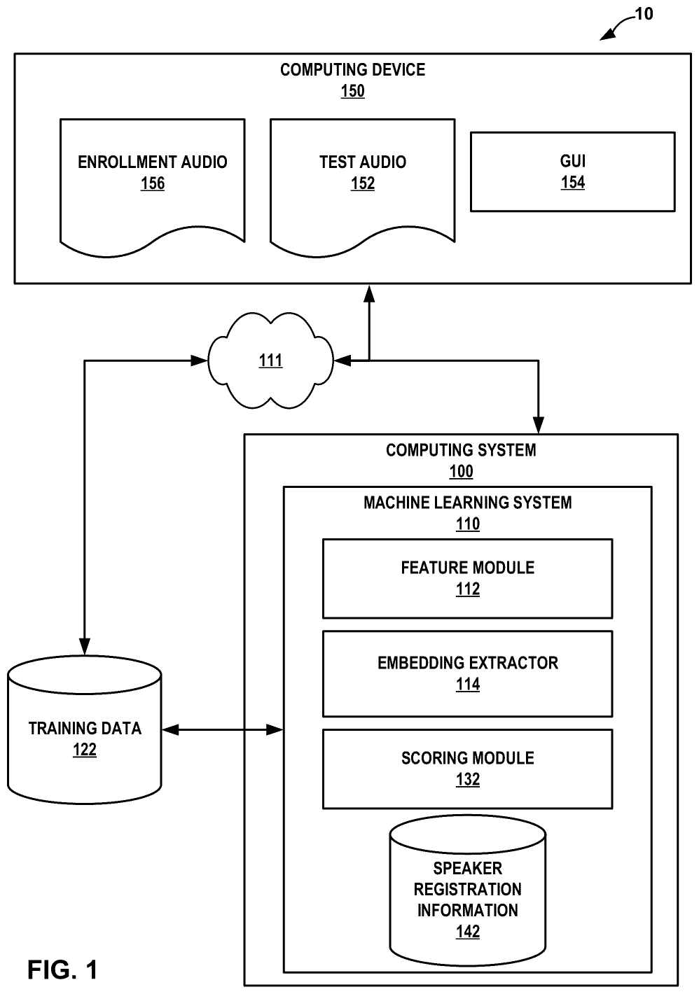

FIG. 1 is a block diagram illustrating example computing environment 10 in which computing system 100 detects whether test audio 152 includes synthetic speech, in accordance with techniques of this disclosure. Computing environment 10 includes computing system 100 and computing device 150. Computing device 150 may be a mobile computing device, such as a mobile phone (including a smartphone), a laptop computer, a tablet computer, a wearable computing device, or any other computing device. In the example of FIG. 1, computing device 150 stores test audio 152 enrollment audio 156, and graphical user interface (GUI) 154. Test audio 152 is audio data that includes one or more audio clips having audio waveforms representing speech purporting to be from a registered speaker. Test audio 152 may include original speech recorded from a speaker as well as synthetic speech in the speaker's voice, i.e., generated and purporting to be from the speaker. Synthetic speech, as described herein, may refer to audio waveforms representing speech generated by one or more synthetic speech generators. Enrollment audio 156 is audio data that includes one or more sample audio clips having audio waveforms representing authentic speech of a registered speaker speaking. Authentic speech, as described herein, may refer to audio waveforms representing speech of a real, authentic human speaking.

GUI 154 is a user interface that may be associated with functionality of computing device 150. For example, GUI 154 of FIG. 1 may be a user interface for a software application associated with detecting synthetic speech in audio clips, such as test audio 152. Although illustrated in FIG. 1 as internal to computing device 150, GUI 154 may generate output for display on an external display device. In some examples, GUI 154 may provide an option for a user of computing device 150 to input enrollment audio 156, including audio clips of a speaker, to register the speaker. GUI 154 may provide an option for a user of computing device 150 to input test audio 152 to detect whether test audio 152 includes audio of synthetic speech purporting to be speech from a registered speaker associated with enrollment audio 156. Although described as a graphical user interface, GUI 154 may represent any type of interface by which a user of computing device 150 can perform operations attributed herein to GUI 154, such as a command line interface, a website or form, a speaker, or some combination thereof.

Although illustrated as external to computing system 100, computing device 150 may be a component of computing system 100. Computing device 150 and computing system 100 may communicate via communication channel 111, which may include a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, or other types of communication channels for transmitting data between computing systems, servers, and computing devices. Alternatively, or in addition, although not shown, computing system 100 may receive test audio 152 and/or enrollment audio 156 from a storage device that interfaces with computing system 100 and that stores test audio 152 and/or enrollment audio 156. Such storage devices may include a USB drive, a disk drive (e.g., solid state drive or hard drive), an optical disc, or other storage device or media. Test audio 152 and/or enrollment audio 156 may be audio that is associated with video or other multimedia. As used herein, an audio clip refers to any audio stored to media. Computing system 100 may obtain enrollment audio 156 and/or test audio 152 from computing device 150, via a network, for example.

Computing system 100 may represent one or more computing devices configured to execute machine learning system 110. Machine learning system 110 may be trained to detect synthetic speech in audio (e.g., test audio 152) based at least on feature information extracted from enrollment audio 156. In the example of FIG. 1, machine learning system 110 includes feature module 112, embedding extractor 114, speaker registration information 142, and scoring module 132. Feature module 112 may include computer readable instructions for applying feature extraction techniques. For example, feature module 112 may include computer readable instructions for applying filter bank techniques to extract acoustic features from audio clips, such as Linear Frequency Cepstral Coefficients (LFCCs), Mel-Frequency Cepstral Coefficients (MFCCs), Power-Normalized Cepstral Coefficients, Constant Q Cepstral Coefficients, or the like. Feature module 112 may include computer readable instructions for applying automatic speech recognition (ASR) techniques to extract phonetic features from audio clips, such as pronunciation of phones or phonemes included in audio clips. For example, feature module 112 may include computer readable instructions for applying a machine learning model (e.g., a deep neural network) to extract phonetic features as deep neural network bottleneck features. Feature module 112 may include one or more machine learning models that are trained to extract acoustic features and phonetic features based on labeled sample speech clips included in training data 122. For example, feature module 112 may include one or more machine learning models trained to extract phonetic features based on training data 122 including sample speech clips labeled for triphone states. Training data 122 may include training data of labeled sample speech clips that may be accessed by machine learning system 110 via communication channel 111. Although illustrated as external to computing system 100 in FIG. 1, training data 122 may be stored at machine learning system 110 or computing device 150.

Embedding extractor 114 may include computer readable instructions for generating embeddings based on acoustic features and phonetic features extracted using feature module 112. For example, embedding extractor 114 may include computer readable instructions for applying a deep learning model (e.g., a neural network, a residual network such as xResNet, etc.) that is trained to generate embeddings that characterize, capture, represent, encapsulate, distill, or otherwise reflect acoustic features and phonetic features. Embedding extractor 114 may include a deep learning model that is trained to distinguish between synthetic speech and authentic speech to generate embeddings for acoustic features and phonetic features based on labeled sample speech clips included in training data 122. For example, embedding extractor 114 may include a deep learning model that is trained to generate embeddings based on training data 122 including sample speech clips labeled for authentic speech and synthetic speech. Embedding extractor 114 may include a deep learning model that is trained to distinguish between synthetic speech and authentic speech. Embedding extractor 114 may include the deep learning model trained to distinguish between synthetic speech and authentic speech to generate embeddings that characterize or capture acoustic and/or phonetic features that the deep learning model is trained to identify as distinctions between authentic speech and synthetic speech. Embedding extractor 114 may store embeddings for registering as speaker registration information 142. Speaker registration information 142 may include one or more storage devices for storing reference or enrollment embeddings associated with acoustic features and phonetic features of speech from a target or registered speaker.

Scoring module 132 may include computer readable instructions for calculating a score representing whether an audio clip (e.g., test audio 152) includes synthetic speech. For example, scoring module 132 may include computer readable instructions for applying Probabilistic Linear Discriminant Analysis (PLDA) techniques to calculate a score representing a likelihood or probability that the audio clip includes synthetic speech. Scoring module 132 may be trained, based on training data 122, to calculate a score that is calibrated to map to a likelihood ratio that the audio clip includes synthetic speech. Scoring module 132 may calculate a score for test audio 152, for example, based on a comparison of reference embeddings associated with enrollment audio 156 and test embeddings associated with test audio 152.

In accordance with techniques described herein, computing system 100 may determine and output an indication of whether test audio 152 includes synthetic speech of a registered speaker associated with enrollment audio 156. Computing system 100 may store acoustic features and phonetic feature information of a registered speaker as speaker registration information 142. For example, computing system 100 may store enrollment or reference embeddings of feature vectors as speaker registration information 142. Computing system 100 may apply speaker registration information 142 to determine whether test audio 152 includes synthetic speech of a registered speaker.

In operation, computing system 100 may register a speaker based on enrollment audio 156. Feature module 112 of machine learning system 110 may generate enrollment feature vectors based on enrollment audio 156. For example, feature module 112 may generate enrollment feature vectors by extracting, based on one or more sample audio clips of a registered speaker speaking that are included in enrollment audio 156, acoustic features and phonetic features from the one or more sample audio clips included in enrollment audio 156. Feature module 112 may include, for example, one or more filter banks (e.g., LFCC filter banks, MFCC filter banks, etc.) for extracting acoustic features from enrollment audio 156 (e.g., one or more sample audio clips of a registered speaker speaking). Feature module 112 may apply the one or more filter banks to extract acoustic features that correspond to acoustic features associated with characteristics of frequency components of audio signals included in enrollment audio 156. For example, feature module 112 may extract acoustic features that correspond to features associated with characteristics of a frequency range of speech spoken by a speaker associated with enrollment audio 156. Acoustic features may include spectral magnitudes (e.g., energy or power with a frequency band) of audio signals in different frequency bands, band energy of audio signals, Linear Frequency Bank (LFB) acoustic features, Linear Frequency Cepstral Coefficients (LFCC) acoustic features, Mel-Frequency Cepstral Coefficients (MFCCs) acoustic features, Log-Mel spectrogram features, Gammatone Filterbank features, Chroma or pitch class features, Power-Normalized Cepstral Coefficients acoustic features, Constant Q Cepstral Coefficients acoustic features, Bark-Frequency Cepstral Coefficients (BFCCs), Linear Predictive Coding (LPC) features, Formant Frequencies, Spectral Flatness and Spectral Centroid of audio signals, or the like. Feature module 112 may apply acoustic feature extraction techniques to identify and extract acoustic features of enrollment audio 156. For example, feature module 112 may apply acoustic feature extraction techniques to decompose signals of enrollment audio 156 into multiple frequency bands. Feature module 112 may apply the acoustic feature extraction techniques to analyze spectral content of the multiple frequency bands to extract acoustic features.

Feature module 112 may, additionally or alternatively, include one or more automatic speech recognition (ASR) machine learning models (e.g., acoustic models used for ASR applications including deep neural networks, time delay neural networks, filter banks, convolutional neural networks, etc.) for extracting phonetic features from enrollment audio 156. Phonetic features may correspond to features associated with characteristics of phones or phonemes included in audio signals. Feature module 112 may extract phonetic features that correspond to phonetic characteristics associated with phones, phonemes, or other linguistic elements of speech of a speaker associated with enrollment audio 156. Feature module 112 may apply ASR techniques to extract phonetic features as ASR bottleneck (BN) features.

Feature module 112 may generate enrollment feature vectors by combining (e.g., concatenating, averaging, summing, computing a product of, min pooling, weighted averaging or summing, applying principal component analysis (PCA), correlation analysis, autoencoding, or other methods of combining feature vectors) extracted acoustic features and phonetic features of enrollment audio 156. Enrollment feature vectors may include an array or matrix with values characterizing acoustic features and phonetic features associated with enrollment audio 156. Feature module 112 may provide the enrollment feature vectors to embedding extractor 114.

Embedding extractor 114 may generate reference embeddings for a speaker to be registered. For example, embedding extractor 114 may include a deep learning model trained to distinguish between synthetic speech and authentic speech. Embedding extractor 114 may include a deep learning model trained to generate, based on feature vectors, embeddings that characterize or capture acoustic and phonetic features that the deep learning model learned as distinctive features between authentic speech and synthetic speech (e.g., acoustic feature artifacts of synthetic speech, phonetic feature artifacts of synthetic speech, etc.). Embedding extractor 114 may apply the deep learning model to output reference embeddings based on enrollment feature vectors. Embedding extractor 114 may generate reference embeddings that characterize, represent, encapsulate, distill, capture, or otherwise reflect acoustic features and phonetic features of authentic speech of a speaker included in enrollment audio 156. In this way, embedding extractor 114 may generate reference embeddings that include speaker specific information, such that scoring module 132 computes scores for test audio 152 that are more speaker aware in order to distinguish between synthetic speech and authentic speech. By using a deep learning model trained to distinguish between synthetic speech and authentic speech, embedding extractor 114 may generate reference embeddings that characterize or capture distinctive acoustic features and phonetic features (e.g., acoustic artifacts, phonetic artifacts, etc.) that may indicate differences between synthetic speech and authentic speech. Embedding extractor 114 may store reference embeddings as speaker registration information 142.

Computing system 100 may determine whether test audio 152 includes synthetic or authentic speech of a speaker associated with enrollment audio 156. Test audio 152, for example, may include an audio file (e.g., waveform audio file format (WAV), MPEG-4 Part 14 (MP4), etc.) with audio of speech purporting to be spoken from a registered speaker. Feature module 112 of machine learning system 110 may extract, based on test audio 152, acoustic features and phonetic features from test audio 152 to generate a test feature vector. Feature module 112 may apply acoustic feature extraction techniques to identify and extract acoustic features of test audio 152. For example, feature module 112 may apply acoustic feature extraction techniques to decompose signals of test audio 152 into multiple frequency bands. Feature module 112 may apply the acoustic feature extraction techniques to analyze spectral content of the multiple frequency bands to extract acoustic features. Feature module 112 may apply one or more filter banks on a linear frequency scale (e.g., uniform separation between filters where the gap between filters do not grow to provide better signal resolution at high frequencies) to extract acoustic features that capture or characterize distinct artifacts left by synthetic speech generators (e.g., acoustic artifacts in a high-frequency range that a human cannot speak in). Feature module 112 may include a filter bank that extracts acoustic features that indicate distinctions between artifacts left by synthetic speech generators and features of authentic speech (e.g., authentic speech of a registered speaker associated with enrollment audio 156). Feature module 112 may encode extracted acoustic features of test audio 152 in a test acoustic feature vector. In other words, feature module 112 may include a filter bank configured to capture discriminate features introduced by synthetic speech generators (e.g., introduced via artifacts left by synthetic speech generators) in an acoustic space.

Feature module 112 may additionally or alternatively generate a test phonetic feature vector. Feature module 112 may generate a test phonetic feature vector by extracting phonetic features from test audio 152. Phonetic features may include mappings of phonetically rich representations or abstractions of speech. For example, phonetic features may include phonetic classes of speech (e.g., manner of articulation, prosodic features, pronunciation, etc.) mapped to phonemes identified in test audio 152. Feature module 112 may apply a machine learning model (e.g., machine learning models for ASR applications) to extract phonetic features as residual phonetic artifacts left by synthetic speech generators (e.g., artifacts associated with pronunciation of a phone or phoneme included in an audio clip). Feature module 112 may apply the machine learning model to extract phonetic features as ASR bottleneck features. Feature module 112 may encode extracted phonetic features of test audio 152 in a test phonetic feature vector. Feature module 112 may generate a test feature vector for test audio 152 based on the test acoustic feature vector and the test phonetic feature vector. For example, feature module 112 may generate a test feature vector by combining (e.g., concatenating, averaging, summing, computing a product of, min pooling, weighted averaging or summing, applying principal component analysis (PCA), correlation analysis, autoencoding, or other methods of combining feature vectors) the test acoustic feature vector for test audio 152 and the test phonetic feature vector for test audio 152. Test feature vectors may include an array or matrix with values that correspond to acoustic features and phonetic features associated with test audio 152.

Embedding extractor 114 of machine learning system 110 may generate test embeddings based on the test feature vector. Embedding extractor 114 may include one or more deep learning models (e.g., Residual Neural Networks (ResNets), other neural networks such as recurrent neural networks (RNNs) or deep neural networks (DNNs), etc.) trained with training data 122 (e.g., sample speech clips labeled for authentic speech and synthetic speech) to extract embeddings from feature vectors. Embedding extractor 114 may include one or more deep learning models trained to distinguish between synthetic speech and authentic speech. Embedding extractor 114 may apply the one or more deep learning models to generate test embeddings based on the test feature vector. By using a deep learning model trained to distinguish between synthetic speech and authentic speech, embedding extractor 114 may generate test embeddings that characterize or capture distinctive acoustic features and phonetic features (e.g., acoustic artifacts, phonetic artifacts, etc.) that may indicate differences between synthetic speech and authentic speech. Test embeddings may include values characterizing, representing, encapsulating, distilling, or otherwise reflecting acoustic features and phonetic features in a high dimensional space. Embedding extractor 114 may provide test embeddings for test audio 152 to scoring module 132.

Scoring module 132 of machine learning system 110 may determine whether test audio 152 includes synthetic speech of a registered speaker based on the test embeddings and the reference embeddings stored at speaker registration information 142. For instance, scoring module 132 may compute, based on the test embeddings and the reference embeddings, a score for test audio 152 that indicates whether test audio 152 includes synthetic speech. Scoring module 132 may leverage a Probabilistic Linear Discriminant Analysis (PLDA) classifier to compute one or more scores based on the test embeddings and the reference embeddings. For example, scoring module 132 may apply PLDA to the test embeddings to generate one or more probabilities (e.g., log-likelihood ratios) representing whether test audio 152 includes synthetic speech. Scoring module 132 may determine the probabilities based on the reference embeddings saved at speaker registration information 142. For example, scoring module 132 may compute one or more scores (e.g., log-likelihood ratios, probabilities, etc.) for test audio 152 by comparing test embeddings to reference embeddings. Scoring module 132 may output an indication of the one or more scores for test audio 152.

Computing system 100 may output, based on the score, an indication of whether test audio 152 includes synthetic speech. Computing system 100 may determine whether test audio 152 includes synthetic speech based on a threshold score applied to the score output by scoring module 132. Computing system 100 may generate and output an indication of the whether test audio 152 includes synthetic speech based on the threshold score (e.g., based on the score satisfying the threshold, generate and output a positive indication that synthetic speech is detected, and/or based on the score not satisfying the threshold, generate and output a negative indication that synthetic speech is not detected). The indication may include a Boolean value (e.g., 1 representing authentic speech, 0 representing synthetic speech), a string (e.g., “Includes synthetic speech,” “Does not include synthetic speech,” etc.), or the like. In some examples, the indication may include a value or string indicating a probability or likelihood that test audio 152 includes synthetic speech. Computing system 100 may output the indication to computing device 150. Computing device 150 may output the indication, to a display device using GUI 154, to allow a user to identify whether test audio 152 includes speech spoken by a speaker associated with enrollment audio 156.

The techniques may provide one or more technical advantages that realize at least one practical application. For example, machine learning system 110 may determine whether a test audio clip (e.g., test audio 152) includes synthetic speech based on analysis of phonetic features of speech in the test audio clip. Typically, systems may analyze acoustic features of audio clips to determine whether synthetic speech is included in the audio clips. However, speech in authentic audio tend to include phonemes (e.g., pronunciations of phones or phonetic pronunciations) that differ than phonemes generated by synthetic speech generators. For example, synthetic speech generators may generate speech that pronounces vowels with phonetic sounds that differ than phonetic sounds associated with how authentic speech pronounces vowels. Phonetic information is a valuable aspect in synthetic speech detection as it models how a speaker pronounces phones, which a synthetic speech generator may not be able to replicate effectively. The machine learning system may generate reference embeddings for registered speakers that allows the machine learning system to observe how registered speakers' voices changes across recording conditions; thereby improving generalization of the machine learning system to detect synthetic speech in real-world conditions. By analyzing phonetic feature vectors that capture, characterize, or otherwise reflect phonetic states of audio, machine learning system 110 may include an additional layer of information for detecting the synthetic nature of synthetic speech.

Machine learning system 110 may accurately determine whether test audio includes synthetic speech based on enrolling registered speakers (e.g., via enrollment audio 156). In the phonetic space, phonemes produced by a registered or target speaker tend to closely lie together. By analyzing phonetic features of registered speakers, machine learning system 110 may embed phonetic speaker information of a speaker to enroll or register the speaker based on reference embeddings generated using embedding extractor 114, for example. Machine learning system 110 may register speakers that may be vulnerable to deep fake attacks (e.g., political figures, celebrities, public figures, etc.). Machine learning system 110 may accurately determine whether test audio includes synthetic speech purporting to be from a registered speaker based on reference embeddings generated for the registered speaker. In this way, machine learning system 110 may leverage speaker specific characteristics embodied in reference embeddings generated for registered speaker to further discriminate between authentic speech of a registered speaker and synthetic speech purporting to be spoken by the registered speaker.

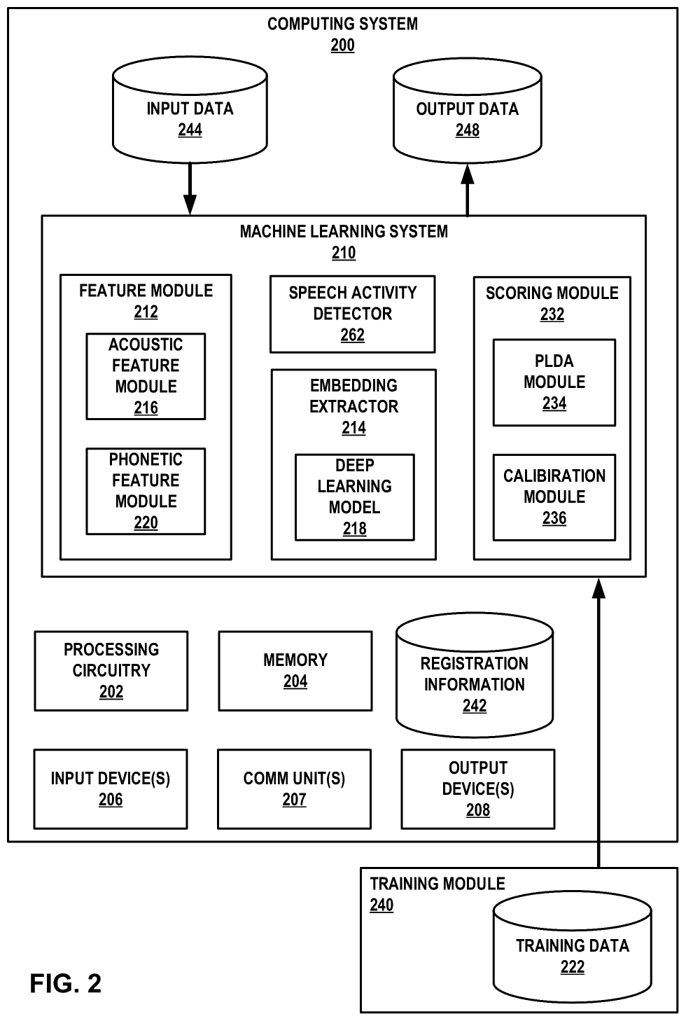

FIG. 2 is a block diagram illustrating example computing system 200 with example machine learning system 210 trained to detect synthetic speech purporting to be spoken by a registered speaker, in accordance with techniques of this disclosure. Computing system 200, machine learning system 210, feature module 212, embedding extractor 214, training data 222, registration information 242, and scoring module 232 of FIG. 2 may be example or alternative implementations of computing system 100, machine learning system 110, feature module 112, embedding extractor 114, training data 122, speaker registration information 142, and scoring module 132 of FIG. 1, respectively.

Training module 240, in the example of FIG. 2, may be stored at a storage device external to computing system 200 (e.g., a separate training computing system). In some examples, training module 240 may be stored at computing system 200. Training module 240 may include a software module with computer-readable instructions for training components of machine learning system 210. Training module 240, in the example of FIG. 2, may include training data 222. Training data 222 may include sample speech clips labeled for authentic speech, synthetic speech, triphone state, or the like.

Computing system 200 comprises any suitable computing system having one or more computing devices, such as servers, desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Computing system 200, in the example of FIG. 2, may include processing circuitry 202, one or more input devices 206, one or more communication units (“COMM” units) 207, and one or more output devices 208 having access to memory 204. One or more input devices 206 of computing system 200 may generate, receive, or process input. Such input may include input from a keyboard, pointing device, voice responsive system, video camera, biometric detection or response system, button, sensor, mobile device, control pad, microphone, presence-sensitive screen, network, or any other type of device for detecting input from a human or machine.

One or more output devices 208 may generate, transmit, or process output. Examples of output are tactile, audio, visual, and/or video output. Output devices 208 may include a display, sound card, video graphics adapter card, speaker, presence-sensitive screen, one or more USB interfaces, video and/or audio output interfaces, or any other type of device capable of generating tactile, audio, video, or other output. Output devices 208 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 206 and one or more output devices 208.

One or more communication units 207 of computing system 200 may communicate with devices external to computing system 200 (or among separate computing devices of computing system 200) by transmitting and/or receiving data, and may operate, in some respects, as both an input device and an output device. In some examples, communication units 207 may communicate with other devices over a network. In other examples, communication units 207 may send and/or receive radio signals on a radio network such as a cellular radio network. Examples of communication units 207 may include a network interface card (e.g., such as an Ethernet card), an optical transceiver, a radio frequency transceiver, a GPS receiver, or any other type of device that can send and/or receive information. Other examples of communication units 207 may include Bluetooth®, GPS, 3G, 4G, and Wi-Fi® radios found in mobile devices as well as Universal Serial Bus (USB) controllers and the like.

Processing circuitry 202 and memory 204 may be configured to execute machine learning system 210 to determine whether an input audio clip includes synthetic speech of a target speaker, according to techniques of this disclosure. Memory 204 may store information for processing during operation of speech activity detector 262, feature module 212, embedding extractor 214, and scoring module 232. In some examples, memory 204 may include temporary memories, meaning that a primary purpose of the one or more storage devices is not long-term storage. Memory 204 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Memory 204, in some examples, also include one or more computer-readable storage media. Memory 204 may be configured to store larger amounts of information than volatile memory. Memory 204 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Memory 204 may store program instructions and/or data associated with one or more of the modules (e.g., speech activity detector 262, feature module 212, embedding extractor 214, and scoring module 232 of machine learning system 210) described in accordance with one or more aspects of this disclosure.

Processing circuitry 202 and memory 204 may provide an operating environment or platform for speech activity detector 262, feature module 212, embedding extractor 214, and scoring module 232, which may be implemented as software, but may in some examples include any combination of hardware, firmware, and software. Processing circuitry 202 may execute instructions and memory 204 may store instructions and/or data of one or more modules. The combination of processing circuitry 202 and memory 204 may retrieve, store, and/or execute the instructions and/or data of one or more applications, modules, or software. Processing circuitry 202 and memory 204 may also be operably coupled to one or more other software and/or hardware components, including, but not limited to, one or more of the components illustrated in FIG. 2. Processing circuitry 202, input devices 206, communication units 207, output devices 208, and memory 204 may each be distributed over one or more computing devices.

In the example of FIG. 2, machine learning system 210 may include speech activity detector 262, feature model 212, embedding extractor 214, and scoring module 232. Speech activity detector 262 may pre-process audio clips included in input data 244. Speech activity detector 262 may identify regions of audio of an audio clip that include speech. Speech activity detector 262 may generate a modified audio clip that includes detected speech portions to remove silent portions, background noise, or the like from audio clips processed using machine learning system 210. Speech activity detector 262 may include a speech activity detection (SAD) model (e.g., a deep neural network) that includes one or more neural networks with two layers, with 500 neurons in the first layer and 100 neurons in the second layer. Speech activity detector 262 may apply the SAD model to output scores, and smooth the scores using a 0.5-second window. Speech activity detector 262 may generate a modified audio clip of detected speech segments by adding one-third of a second of padding at both ends of detected speech segments to account for any missing parts. Speech activity detector 262 may include a SAD model trained by training module 240. Training module 240 may train speech activity detector 262 to generate modified audio clips based on a 20-dimensional Mel-Frequency Cepstral Coefficients (MFCC) features obtained from a temporal window of 0.31 seconds and a normalization window of 0.5 seconds for mean and variance.

Speech activity detector 262 may input, to feature module 212, a modified audio clip as an audio clip that includes detected speech portions of an audio clip included in input data 244. Feature module 212 may process the modified audio clip as the audio clip as discussed in more detail below.

Feature module 212 may include acoustic feature module 216 and phonetic feature module 220. Acoustic feature module 216 may include a software module with computer-readable instructions for extracting acoustic features (e.g., spectral magnitudes, band energy, LFB features, LFCC features, MFCC features, etc.) from audio clips. Acoustic feature module 216 may generate acoustic feature vectors that characterize or capture acoustic features from audio clips. For example, acoustic feature module 216 may be configured to extract acoustic features that correspond to features associated with characteristics of frequency components of audio signals. Phonetic feature module 220 may include a software module with computer-readable instructions for extracting phonetic features (e.g., manner of articulation, prosodic features, pronunciation, etc.) from audio clips. Phonetic feature module 220 may apply automatic speech recognition (ASR) techniques to generate phonetic feature vectors that characterize or capture phonetic features from audio clips. Phonetic feature module 220 may, for example, analyze phonemes of speech in audio clips by generating phonetic feature vectors that characterize or capture a phonetic context, such as articulations of a series of phonemes (e.g., a series of phonemes that make up a word or a sentence). Phonetic feature module 220 may be configured to extract phonetic features that correspond to features associated with characteristics of phones or phonemes included in audio signals. Feature module 212 may combine (e.g., concatenate, average, sum, compute a product of, min pooling, weighted average or sum, apply principal component analysis (PCA), correlation analysis, autoencoding, or other methods of combining feature vectors) acoustic feature vectors, generated using acoustic feature module 216, and phonetic feature vectors, generated using phonetic feature module 220, to generate feature vectors that characterize or capture features in both the acoustic and phonetic space. Feature module 212 may combine acoustic feature vectors and phonetic feature vectors using a simple stacking combination. Feature module 212 may input generated feature vectors to embedding extractor 214.

Training module 240 may train feature module 212 to extract acoustic features and phonetic features of audio clips. Training module 240 may train, based on labeled sample speech clips of training data 222, acoustic feature module 216 of feature module 212 to extract acoustic features of audio clips. Training module 240 may train a machine learning model or a filter bank of acoustic feature module 216 to identify and extract distinct acoustic artifacts (e.g., frequency regions outside the fixed spectral range of human speech) with high spectral resolution over a pre-defined time window. For example, training module 240 may train acoustic feature module 216 to extract 20-dimensional LFCC features from a 25 millisecond window with a 10 millisecond frame shift. Training module 240 may train acoustic feature module 216 to apply one or more filter banks on a linear-frequency scale such that the gap between filters does not grow with frequency. In this way, acoustic feature module 216 may be trained, by training module 240, to extract acoustic features (e.g., LFCC features) with better signal resolution at high frequencies.

Training module 240 may train, based on labeled sample speech clips of training data 222, phonetic feature module 220 to extract phonetic features of audio clips. Training module 240 may train a machine learning model (e.g., a deep neural network acoustic model used for ASR applications) of phonetic feature module 220 to extract phonetic features of audio clips. For example, training module 240 may use Kaldi speech recognition toolkit to train phonetic feature module 220 to extract phonetic features as 40-dimensional MFCC features for every speech frame. Training module 240 may train phonetic feature module 220 to apply 15 stages of low-rank factorized layers in a Time Delay Neural Network (TDNN) acoustic model based on lattice-free maximum mutual information (LF-MMI) criterion stored at training data 222. Training module 240 may train phonetic feature module 220 based on training data 222 that includes training data that is multi-conditioned to improve phonetic feature extraction in noisy environments. In general, as phonetic feature module 220 processes audio clips to extract phonetic features, phonetic information propagates from the acoustic domain to the linguistic domain. Training module 240 may train phonetic feature module 220 to extract phonetic features prior to a soft max layer. Training module 240 may train phonetic feature module 220 with training data 222 that includes training data with augmented sample speech clips for making phonetic feature extraction more robust. In some instances, training module 240 may train and/or fine-tune a machine learning model (e.g., a convolutional neural network) of feature module 212 to extract feature vectors from audio clips.

Embedding extractor 214, in the example of FIG. 2, may include deep learning model 218. Deep learning model 218 may include a software module with computer-readable instructions for a machine learning model (e.g., a residual neural network) trained to generate embeddings based on feature vectors that characterize, represent, encapsulate, capture, or otherwise reflect features in both the acoustic space and phonetic space. Deep learning model 218 may include a machine learning model that is trained, using training module 240, to distinguish between synthetic speech and authentic speech. Training module 240 may train, based on sample speech clips labeled for authentic speech and synthetic speech included in training data 222, deep learning model 218 to distinguish between synthetic speech and authentic speech when generating embeddings. Training data 222 may include sample speech clips of speech recorded throughout various environmental conditions to improve training of machine learning system adaptability to real-world conditions. Training data 222 may include a plurality of labeled sample speech clips. For example, training module 240 may train deep learning model 218 to generate an embedding (e.g., a reference embedding or a test embedding) based on sample speech clips labeled for authentic speech, synthetic speech, triphone states, etc. included in training data 222. Training module 240 may iteratively train and improve the performance of deep learning model 218 using techniques such as benchmarking. In this way, deep learning model 218 may learn what represents phonetic signals or changes in speech when processing feature vectors.

Deep learning model 218 may include a machine learning model, such as a deep neural network with an X-ResNet architecture, trained to distinguish between synthetic speech and authentic speech when generating embeddings based on feature vectors that characterize or capture acoustic features and phonetic features. Deep learning model 218 may include a deep neural network with an X-ResNet architecture that utilizes more discriminant information from input features (e.g., acoustic features and phonetic features). For example, deep learning model 218 may be a deep neural network including a residual network architecture with a modified input stem including 3×3 convolutional layers with 32 filters in the first two layers, and 64 filters in the last layer. In the first residual stage, deep learning model 218 processes the full-sized input. In subsequent stages, deep learning model 218 down-samples the input and doubles the number of filters to maintain computational consistency. Deep learning model 218 may down sample the input by adding a 2×2 average pooling layer. Deep learning model 218 may apply a 1×1 convolution to increase the number of feature maps, matching the output of the residual path. In the final output of the residual stages, deep learning model 218 may apply statistical pooling and embedding layers. Deep learning model 218 may generate and output embeddings from the last layer of the X-ResNet before the final soft-max layer. In some instances, deep learning model 218 may include one or more Squeeze-and-Excitation (SE) blocks to adjust the inter-dependencies between convolutional channels by creating a global feature, resulting in higher weights for dominant channels. Deep learning model 218 may apply the one or more SE blocks by using global average pooling to generate independent channel weights with more emphasis on the most significant channels (e.g., via a bottleneck architecture where the first layer reduces dimensions through a Rectified Linear Unit activation, and the next layer extends the dimension with sigmoid activations).

In some instances, training module 240 may train deep learning model 218 to enhance capabilities of a generating embeddings. Training module 240 may train deep learning model 218 to apply a one-class feature learning technique during the X-ResNet training. Training module 240 may apply sample speech clips of training data 222 labeled as authentic speech to train the embedding space of deep learning model 218 to avoid overfitting to known speech classes. Training module may train deep learning model 218 according to an OC-Softmax function, such as the following function:

$${L}_{OC} = \frac{1}{N} {\sum }_{i = 1}^{N} log ( 1 + {e}^{α ( {m}_{{y}_{i}} - {\hat{w}}_{0} {\hat{x}}_{i} ) {( - 1 )}^{{y}_{i}}} )$$

where \hat{x}ᵢ∈ [symbol] ^{D} and ŵ₀∈ [symbol] ^{D} represents the normalized target-class embeddings and weight-vector, respectively. yᵢ∈0,1 denotes sample labels of sample speech clips of training data 222, and m₀, m₁∈[−1,1], where m₀>m₁ are the angular margins between classes.

In accordance with techniques described herein, machine learning system 210 may determine whether an audio clip includes synthetic speech of a registered speaker. Machine learning system 210 may obtain input data 244 that includes audio clips of sample speech clips of a speaker to be registered (e.g., enrollment audio 156) and/or a speech clip to be analyzed for synthetic speech (e.g., test audio 152 of FIG. 1). In some instances, machine learning system 210 may obtain input data 244 from a user device (e.g., computing device 150 of FIG. 1) via a network or wired connection. In some examples, input data 244 may be directly uploaded to computing system 200 by an administrator of computing system 200 via input devices 206 and/or communication units 207. For example, input data 244 may include audio clips, downloaded from the Internet (e.g., from a social media platform, from a streaming platform, etc.), that a user operating computing system 200 knows to be authentic speech of a speaker to be registered. Additionally, or alternatively, input data 244 may include an audio clip, downloaded from the Internet (e.g., from a social media platform, from a streaming platform, etc.), that a user operating computing system 200 believes may include synthetic speech of a registered speaker.

Feature module 212 of machine learning system 210 may generate feature vectors based on audio clips included in input data 244. Feature module 212 may generate feature vectors by, for example, decomposing signals of audio clips into multiple frequency bands. In instances where input data 244 includes sample speech clips of a speaker to be registered, acoustic feature module 216 of feature module 212 may generate enrollment acoustic feature vectors that characterize or otherwise capture acoustic features of a speaker to be registered. In instances where input data 244 includes a test audio clip (e.g., an audio clip to be analyzed for synthetic speech), acoustic feature module 216 may generate test acoustic feature vectors that characterize or otherwise capture acoustic features of speech included in the test audio clip.

Phonetic feature module 220 of feature module 212 may generate phonetic feature vectors that characterize phonetic features (e.g., phonetic contexts) of audio clips. In instances where input data 244 includes sample speech clips of a speaker to be registered, phonetic feature module 220 may generate enrollment phonetic feature vectors that characterize or capture phonetic features of the speaker to be registered. In instances where input data 244 includes a test audio clip (e.g., an audio clip to be analyzed for synthetic speech), phonetic feature module 220 may generate test phonetic feature vectors that characterize or capture phonetic features of speech included in the test audio clip. Feature module 212 may combine (e.g., concatenate, average, sum, compute a product of, min pooling, weighted average or sum, apply principal component analysis (PCA), correlation analysis, autoencoding, or other methods of combining feature vectors) enrollment acoustic feature vectors and enrollment phonetic feature vectors to generate enrollment feature vectors. Feature module 212 may store enrollment feature vectors at registration information 242. Feature module 212 may combine (e.g., concatenate, average, sum, compute a product of, min pooling, weighted average or sum, apply principal component analysis (PCA), correlation analysis, autoencoding, or other methods of combining feature vectors) test acoustic feature vectors and test phonetic feature vectors to generate test feature vectors. Feature module 212 may provide enrollment feature vectors and test feature vectors to embedding extractor 214.

Deep learning model 218 of embedding extractor 214 may process feature vectors to generate embeddings. In instances where deep learning model 218 processes enrollment feature vectors to register a speaker, deep learning model 218 may generate reference embeddings. Deep learning model 218 may be trained to distinguish between synthetic speech and authentic speech when generating reference embeddings that characterize, represent, encapsulate, distill, capture, or otherwise reflect acoustic features and phonetic features represented in the enrollment feature vectors. Deep learning model 218 may generate reference embeddings that include speaker specific information such that scoring module 232 may compute a score for test audio based on reference embeddings are more speaker aware in order to distinguish between synthetic speech and authentic speech of a registered speaker. By using deep learning model 218 that is trained to distinguish between synthetic speech and authentic speech, embedding extractor 214 may generate reference embeddings that characterize or capture distinctive acoustic features and phonetic features (e.g., acoustic artifacts, phonetic artifacts, etc.) that may indicate differences between synthetic speech and authentic speech. Deep learning model 218 may store reference embeddings for registered speaker at registration information 242. Registration information 242 may include one or more storage devices configured to store reference embeddings generated using embeddings extractor 214.

In instances where deep learning model 218 processes test feature vectors to determine whether test audio includes synthetic speech, machine learning model may generate test embeddings. Deep learning model 218 may generate test embeddings that characterize, represent, encapsulate, distill, capture, or otherwise reflect acoustic features and phonetic features represented in the test feature vectors. By using deep learning model 218 that is trained to distinguish between synthetic speech and authentic speech, embedding extractor 214 may generate test embeddings that characterize or capture distinctive acoustic features and phonetic features (e.g., acoustic artifacts, phonetic artifacts, etc.) that may indicate differences between synthetic speech and authentic speech. Deep learning model 218 may output the test embeddings to scoring module 232.

Scoring module 232 may compute a score based on the test embeddings and the reference embeddings generated by deep learning model 218. Scoring module 232 may retrieve reference embeddings from registration information 242. Scoring module 232 may apply PLDA to compute scores based on test embeddings and reference embeddings. Scoring module 232 may reduce dimensions of test embeddings with a linear discriminant analysis (LDA) transformation and gaussianization of the input test embeddings. For example, scoring module 232 may process test embeddings according to the following equation:

$${w}_{i} = μ + {U}_{1} \cdot {x}_{1} + {ϵ}_{i}$$

where wᵢ represents the transformed test embeddings, u represents the mean vector, U₁ represents the eigen matrix, x₁ represents the hidden factor, and Et represents the residual variability. Scoring module 232 may provide the transformed test embeddings to PLDA module 234.

PLDA module 234 of scoring module 232 may compute a score for a test audio clip based on the reference embeddings and test embeddings. For example, PLDA module 234 may compute the score by applying PLDA techniques to compare the test embeddings to reference embeddings. PLDA module 234 may leverage a PLDA classifier to provide better generalization across real-world data conditions. PLDA module 234 may compute a score as a raw score representing a likelihood or probability that the test audio includes synthetic speech. For example, PLDA module 234 may compute a raw score based on a comparison of test embeddings to one or more reference embeddings. PLDA module 234 may provide the raw score to calibration module 236.

Calibration module 236 of scoring module 232 may compute, based on a calibration of a raw score, a score for test audio. Calibration module 236 may compute, based on the raw score, a similarity score as a log likelihood ratio. For example, calibration module 236 may compute the similarity score based on a calibration of a raw score. For instance, calibration module 236 may map raw scores to a scale such that raw score may be interpreted as probability ratios or likelihood ratios. Calibration module 236 may output the similarity score indicating a likelihood a test audio clip includes synthetic speech. Training module 240 may train calibration module 236 based on training data 222. For example, training module 240 may train calibration module 236 based on training data 222 including sample raw scores associated with sample speech clips that are labeled with whether the sample speech include synthetic speech or authentic speech.

In some instances, scoring module 232 may process the similarity score output by calibration module 236 to generate an indication of whether the test audio clip includes synthetic speech. For example, scoring module 232 may apply a threshold similarity score to determine whether the similarity score associated with the test audio clip satisfies the threshold. Based on the similarity score satisfying the threshold, scoring module 232 may output, via output devices 208 and as output data 248, an indication that the test audio clip includes authentic speech. Based on the similarity score not satisfying the threshold, scoring module 232 may output, via output devices 208 and/or as output data 248, an indication that the test audio clip includes synthetic speech.

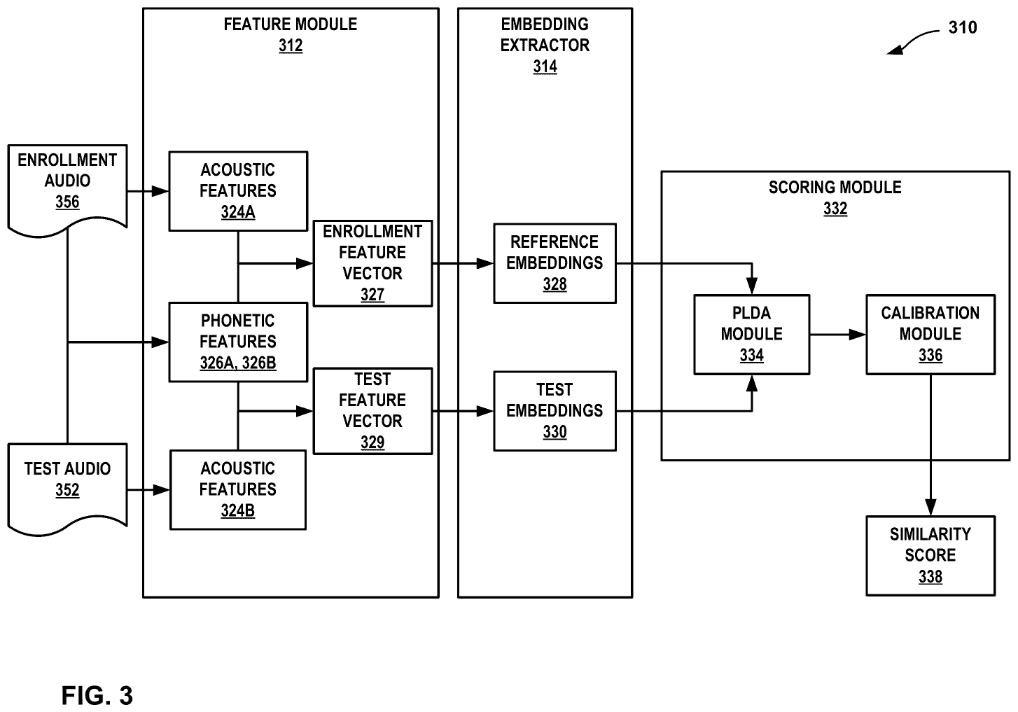

FIG. 3 is a conceptual diagram illustrating example machine learning system 310 of a computing system for registering a speaker and detecting synthetic speech in example test audio 352 clip, in accordance with techniques of this disclosure. Enrollment audio 356, test audio 352, feature module 312, embedding extractor 314, and scoring module 332 of FIG. 3 may be example or alternative implementations of enrollment audio 156, test audio 152, feature module 112, embedding extractor 114, and scoring module 132 of FIG. 1, respectively. PLDA module 334 and calibration module 336 of FIG. 3 may be example or alternative implementations of PLDA module 234 and calibration module 236 of FIG. 2, respectively.

In the example of FIG. 3, machine learning system 310 may provide enrollment audio 356 and test audio 352 to feature module 312. During registration of a speaker associated with enrollment audio 356, feature module 312 may process enrollment audio 356 to extract acoustic features 324A and phonetic features 326A. Acoustic features 342A may include a set of acoustic features that correspond to features associated with characteristics of frequency components of audio signals included in enrollment audio 356. Phonetic features 326A may include a set of phonetic features that correspond to features associated with characteristics of phones or phonemes included in audio signals of enrollment audio 356. Feature module 312 may combine (e.g., concatenate, average, sum, compute a product of, min pooling, weighted average or sum, apply principal component analysis (PCA), correlation analysis, autoencoding, or other methods of combining feature vectors) acoustic features 324A and phonetic features 326A to generate enrollment feature vector 327. Enrollment feature vector 327 may include a vector or array characterizing or capturing acoustic features 324A and phonetic features 326A. Feature module 312 may provide enrollment feature vector 327 to embedding extractor 314. Embedding extractor 314 may process enrollment feature vector 327 to generate reference embeddings 328. Reference embeddings 328 may include enrollment embeddings for a particular speaker associated with enrollment audio 156. Embedding extractor 314 may generate reference embeddings 328 to include speaker specific information to allow scoring module 332 to compute scores for test audio 352 that are more speaker aware in order to distinguish between synthetic speech and authentic speech of a speaker associated with enrollment audio 356. Embedding extractor 314 may output reference embeddings 328 to scoring module 332.

During inference time, when machine learning system 310 is tasked with determining whether test audio 352 includes synthetic speech, feature module 312 may extract acoustic features 324B and phonetic features 326B from test audio 352. Acoustic features 324B may include a set of acoustic features that correspond to features associated with characteristics of frequency components of audio signals included in test audio 352. Phonetic features 326B may include a set of phonetic features that correspond to features associated with characteristics of phones or phonemes included in audio signals of test audio 352. Feature module 312 may combine (e.g., concatenate, average, sum, compute a product of, min pooling, weighted average or sum, apply principal component analysis (PCA), correlation analysis, autoencoding, or other methods of combining feature vectors) acoustic features 324B and phonetic features 326B to generate test feature vector 329. Test feature vector 329 may include a vector or array characterizing or capturing acoustic features 324B and phonetic features 326B. Feature module 312 may output test feature vector 329 to embedding extractor 314. Embedding extractor 314 may process test feature vector 329 to generate test embeddings 330. Test embeddings 330 may include one or more embeddings that characterize, represent, encapsulate, distill, capture, or otherwise reflect acoustic features 324B and phonetic features 326B associated with speech included in test audio 352. Embedding extractor 314 may output test embeddings 330 to scoring module 332.

Scoring module 332 may compute a score based on reference embeddings 328 and test embeddings 330. PLDA module 334 of scoring module 332 may compute a raw score based on a comparison of test embeddings 330 to reference embeddings 328. For example, PLDA module 334 may compute the raw score by determining variabilities that test embeddings 330 have with respect to reference embeddings 328. PLDA module 334 may output the raw score to calibration module 336.

Calibration module 336 may compute, based on a calibration of the raw score output by PLDA module 334, similarity score 338. Similarity score 338 may include one or more values (e.g., one or more log likelihood ratios, probabilities, etc.) indicating a likelihood that test audio 352 includes synthetic speech. For example, calibration module 336 may be trained to compute similarity score 338 by mapping the raw score to a scale of log likelihood ratios. Calibration module 336 may output similarity score 338. In some examples, scoring module 332 may apply a threshold to similarity score 338 to generate an indication of whether test audio 352 includes synthetic speech. Scoring module 332 may output the indication to a display device.

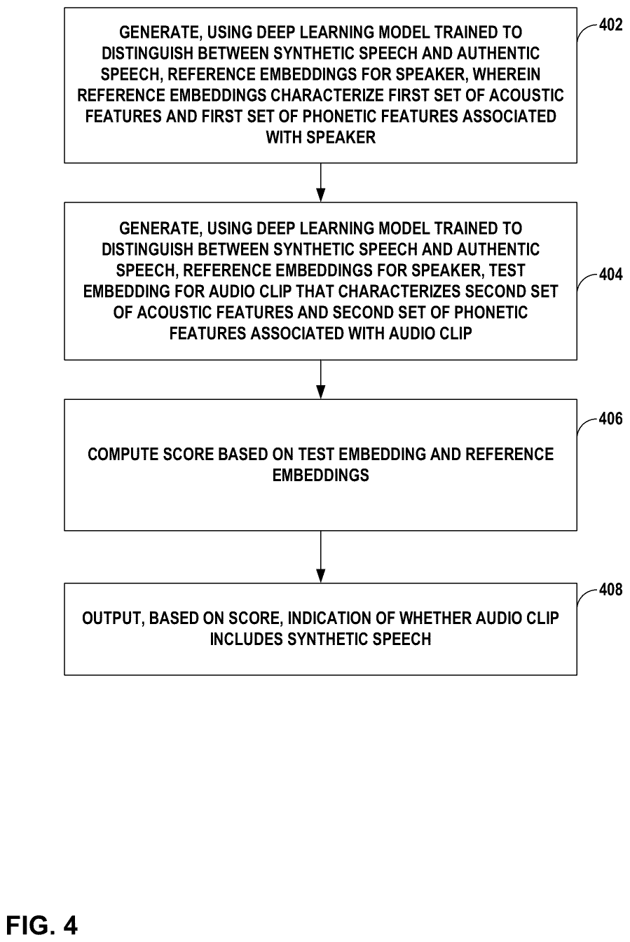

FIG. 4 is a flowchart illustrating an example mode of operation for determining synthetic speech in an audio clip, in accordance with techniques of this disclosure. FIG. 4 may be discussed with respect to FIG. 1 for example purposes only.

Machine learning system 110 of computing system 100 may generate, using a deep learning model trained to distinguish between synthetic speech and authentic speech, reference embeddings for a speaker, wherein the reference embeddings characterize a first set of acoustic features and a first set of phonetic features associated with the speaker (402). For example, feature module 112 may extract, based on one or more sample audio clips of the speaker speaking (e.g., sample audio clips included in enrollment audio 156), the first set of acoustic features and the first set of phonetic features. Feature module 112 may apply one or more filter banks to extract the first set of acoustic features that correspond to features associated with characteristics of frequency components of audio signals included in the one or more sample audio clips of the speaker speaking (e.g., audio signals included in audio clips of enrollment audio 156). Feature module 112 may apply ASR techniques to extract the first set of phonetic features that correspond to features associated with characteristics of phone or phonemes included in the one or more sample audio clips of the speaker speaking (e.g., audio signals included in audio clips of enrollment audio 156). Feature module 112 may combine the first set of acoustic features and the first set of phonetic features to generate an enrollment feature vector. Feature module 112 may provide the enrollment feature vector to embedding extractor 314. Embedding extractor 114 may generate, using a deep learning model trained to distinguish between synthetic speech and authentic speech, the one or more reference embeddings based on the enrollment feature vector.

Machine learning system 110 may generate, using the deep learning model trained to distinguish between synthetic speech and authentic speech, a test embedding for an audio clip that characterizes a second set of acoustic features and a second set of phonetic features associated with the audio clip (404). For example, feature module 112 may apply one or more filter banks to extract, based on test audio 152, the second set of acoustic features that correspond to features associated with characteristics of frequency components of audio signals included in test audio 152. Feature module 112 may apply ASR techniques to extract, based on test audio 152, the second set of phonetic features that correspond to features associated with characteristics of phone or phonemes included in audio signals of test audio 152. Feature module 112 may combine the second set of acoustic features and the second set of phonetic features to generate a test feature vector. Feature module 112 may provide the test feature vector to embedding extractor 114. Embedding extractor 114 may generate, using a deep learning model trained to distinguish between synthetic speech and authentic speech, the test embedding based on the test feature vector.

Machine learning system 110 may compute a score based on the test embedding and the one or more reference embeddings (406). For example, scoring module 132 may compute the score by applying PLDA techniques to compute one or more log likelihood ratios by comparing the test embedding to the one or more reference embeddings. In some examples, scoring module 132 may compute a raw score based on a comparison of the test embedding to the one or more reference embeddings. Scoring module 132 may compute, based on a calibration of the raw score, the score for test audio 152.

Machine learning system 110 may output, based on the score, an indication of whether the audio clip includes synthetic speech (408). For example, scoring module 132 may output the indication of whether test audio 152 includes synthetic speech based on whether the score for test audio 152 satisfies a threshold. For instance, scoring module 132 may determine, based on the score for test audio 152 satisfying a threshold, that test audio 152 includes synthetic speech. Based on the score for test audio 152 satisfying the threshold, machine learning system 110 may output, to computing device 150, an indication that test audio 152 includes synthetic speech.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for detecting synthetic speech of a speaker in an audio clip, comprising:
generating, using a deep learning model trained to distinguish between synthetic speech and authentic speech, one or more reference embeddings for the speaker, wherein the one or more reference embeddings characterize a first set of acoustic features and a first set of phonetic features associated with the speaker;
generating, using the deep learning model trained to distinguish between synthetic speech and authentic speech, a test embedding for an audio clip that characterizes a second set of acoustic features and a second set of phonetic features associated with the audio clip;
computing a score based on the test embedding and the one or more reference embeddings; and
outputting, based on the score, an indication of whether the audio clip includes synthetic speech.

2. The method of claim 1, wherein generating the one or more reference embeddings for the speaker comprises:
extracting, based on one or more sample audio clips of the speaker speaking, the first set of acoustic features and the first set of phonetic features;
combining the first set of acoustic features and the first set of phonetic features to generate an enrollment feature vector; and
generating the one or more reference embeddings based on the enrollment feature vector, wherein the one or more reference embeddings include speaker specific information, and wherein computing the score based on the one or more reference embeddings is more speaker aware in order to distinguish between synthetic speech and authentic speech of the speaker.

3. The method of claim 1, wherein generating the test embedding for the audio clip comprises:
extracting, based on the audio clip, the second set of acoustic features and the second set of phonetic features;
combining the second set of acoustic features and the second set of phonetic features to generate a test feature vector; and
generating the test embedding based on the test feature vector.

4. The method of claim 1, wherein outputting the indication comprises: based on the score satisfying a threshold, outputting an indication that the audio clip includes synthetic speech.

5. The method of claim 1, wherein computing the score based on the test embedding and the one or more reference embeddings comprises: computing one or more log-likelihood ratios by comparing the test embedding to the one or more reference embeddings.

6. The method of claim 1, wherein computing the score comprises:
computing a raw score based on a comparison of the test embedding to the one or more reference embeddings; and
computing, based on a calibration of the raw score, the score.

7. The method of claim 1, wherein the first set of acoustic features and the second set of acoustic features correspond to features associated with characteristics of frequency components of audio signals.

8. The method of claim 1, wherein the first set of phonetic features and the second set of phonetic features correspond to features associated with characteristics of phones or phonemes included in audio signals.

9. The method of claim 1, further comprising: training, based on training data, a deep learning model to generate the one or more reference embeddings and generate the test embedding, wherein the training data includes sample speech clips labeled for authentic speech and synthetic speech.

10. The method of claim 9, wherein the deep learning model includes a residual network architecture.

11. A computing system comprising processing circuitry and memory for executing a machine learning system, the machine learning system configured to:
generate, using a deep learning model trained to distinguish between synthetic speech and authentic speech, one or more reference embeddings for the registered speaker, wherein the one or more reference embeddings specify characterize a first set of acoustic features and a first set of phonetic features associated with the registered speaker;
generate, using the deep learning model trained to distinguish between synthetic speech and authentic speech, a test embedding for an audio clip that specifies characterizes a second set of acoustic features and a second set of phonetic features associated with the audio clip;
compute a score based on the test embedding and the one or more reference embeddings; and
output, based on the score, an indication of whether the audio clip includes synthetic speech.

12. The computing system of claim 11, wherein to generate the one or more reference embeddings for the speaker, the machine learning system is configured to:
extract, based on one or more sample audio clips of the speaker speaking, the first set of acoustic features and the first set of phonetic features;
combine the first set of acoustic features and the first set of phonetic features to generate an enrollment feature vector; and
generate the one or more reference embeddings based on the enrollment feature vector, wherein the reference embeddings include speaker specific information, and wherein computing the score based on the one or more reference embeddings is more speaker aware in order to distinguish between synthetic speech and authentic speech of the speaker.

13. The computing system of claim 11, wherein to generate the test embedding for the audio clip, the machine learning system is configured to:
extract, based on the audio clip, the second set of acoustic features and the second set of phonetic features;
combine the second set of acoustic features and the second set of phonetic features to generate a test feature vector; and
generate the test embedding based on the test feature vector.

14. The computing system of claim 11, wherein to output the indication, the machine learning system is configured to output, based on the score satisfying a threshold, an indication that the audio clip includes synthetic speech.

15. The computing system of claim 11, wherein to compute the score, the machine learning system is configured to compute one or more log-likelihood ratios by comparing the test embedding to the one or more reference embeddings.

16. The computing system of claim 11, wherein the first set of acoustic features and the second set of acoustic features correspond to features associated with characteristics of frequency components of audio signals.

17. The computing system of claim 11, wherein the first set of phonetic features and the second set of phonetic features correspond to features associated with characteristics of phones or phonemes included in audio signals.

18. Computer-readable storage media comprising machine readable instructions for configuring processing circuitry to:
generate, using a deep learning model trained to distinguish between synthetic speech and authentic speech, one or more reference embeddings for the registered speaker, wherein the one or more reference embeddings specify characterize a first set of acoustic features and a first set of phonetic features associated with the registered speaker;
generate, using a deep learning model trained to distinguish between synthetic speech and authentic speech, a test embedding for an audio clip that specifies characterizes a second set of acoustic features and a second set of phonetic features associated with the audio clip;
compute a score based on the test embedding and the one or more reference embeddings; and
output, based on the score, an indication of whether the audio clip includes synthetic speech.

19. The computer-readable storage media of claim 18, wherein to generate the one or more reference embeddings for the speaker, the processing circuitry is configured to:
extract, based on one or more sample audio clips of the speaker speaking, the first set of acoustic features and the first set of phonetic features;
combine the first set of acoustic features and the first set of phonetic features to generate an enrollment feature vector; and
generate the one or more reference embeddings based on the enrollment feature vector, wherein the reference embeddings include speaker specific information, and wherein computing the score based on the one or more reference embeddings is more speaker aware in order to distinguish between synthetic speech and authentic speech of the speaker.

20. The computer-readable storage media of claim 18, wherein to generate the test embedding for the audio clip, the processing circuitry is configured to:
extract, based on the audio clip, the second set of acoustic features and the second set of phonetic features;
combine the second set of acoustic features and the second set of phonetic features to generate a test feature vector; and
generate the test embedding based on the test feature vector.
